(19) United States
(12) Patent Application Publication
(10) Pub. No.: US 2005/0116531 A1
(43) Pub. Date: Jun. 2, 2005

(54) Vehicle wheel comprising a fastening device for sensors

(76) Inventor: Otto Lehmann, Gaggenau (DE)

Correspondence Address: KLAUS J. BACH, 4407 TWIN OAKS DRIVE, MURRYSVILLE, PA, 15668, US

(21) Appl. No.: 10/998,361

(22) Filed: Nov. 27, 2004

Related U.S. Application Data
(63) Continuation-in-part of application No. PCT/EP03/03815, filed on Apr. 12, 2003.

(30) Foreign Application Priority Data
Jun. 1, 2002 (DE) 102 24 444.8

(51) Int. Cl. B60B 21/00

(52) U.S. Cl. 301/95.101

(57) ABSTRACT

In a vehicle wheel with a rim for supporting a tire and a mounting device for a sensor for detecting at least one measurement value in the interior of the tire, the rim has a bore extending between the interior and an area ambient to the wheel into which the mounting device is inserted and in which it is sealingly retained.

This is a Continuation-In-Part application of international application PCT/EP03/03815 filed Apr. 12, 2003 and claiming the priority of German application 102 24 444.8 filed Jun. 1, 2002.

### BACKGROUND OF THE INVENTION

The invention relates to a vehicle wheel with a rim, a tire and a mounting device for a sensor for sensing conditions within the tire.

DE 196 26 446 A1 discloses a vehicle wheel with a tire and a sensor mounted on the vehicle wheel for detecting the tire air pressure. As mounting device, a clamping element is provided which can be attached to the rim in the well base thereof, for example, in a recess or opening so as to be connected to the rim in a force and form-locking manner.

It is the object of the present invention to provide an alternative mounting arrangement by which the fastening device can be attached to the wheel rim in a simple and reliable manner.

### SUMMARY OF THE INVENTION

In a vehicle wheel with a rim for supporting a tire and a mounting device for a sensor for detecting at least one measurement value in the interior of the tire, the rim has a bore extending between the interior and an area ambient to the wheel into which the mounting device is inserted and in which it is sealingly retained.

The mounting arrangement is disposed in a space formed by the rim and the tire. This space will be called herein interior space. All other area around the rim and the tire will be called ambient area.

In accordance with the invention, a mounting area is provided in the interface area between the interior space and the ambient area. This mounting area is sealingly closed by the fastening device. The fastening device provides—in addition to the scaling—for a firm support for the sensor on the rim. The fastening device is for example connected to the rim by riveting or by bolting. By the accommodation of the fastening device in the mounting area, a particularly secure connection of the fastening device with the rim can be achieved. Since the connecting area between the rim and the fastening device is sealed, neither dirt nor moisture can enter the interior space of the rim, nor can pressurized tire air leak to the ambient area. The fastening device is firmly retained in the connecting area of the rim. A sensor can be mounted to the fastening device. Since the fastening device for the sensor is mounted to the rim independently of the sensor, the wheel comprising the rim, the tire and the fastening device can be operated with or without sensor.

In a particular embodiment of the invention, the fastening device is arranged in the well base of the rim. The well base is the radial recess in the center part of the rim. In the well base, the distance between the rim and the tire is maximal. In this way, a sensor mounted onto the fastening device is best protected from destruction during the mounting of the tire. The deep well base is the area of the rim with the smallest radius. This area is also closest to the wheel axis so that minimal centrifugal forces are generated by the fastening device and any sensor mounted thereto. Any static imbalance generated by the fastening device and the sensor attached thereto is therefore minimal. In addition, the deep well is axially centered in the rim. As a result, also, the dynamic imbalance generated by the fastening device and the sensor is minimal.

Preferably, the fastening device is provided with a contoured head. The contoured head is preferably spherical and therefore particularly suitable for mounting a sensor thereto in a variable orientation so that the sensor can be optimally positioned in the rim.

Further features and advantages of the invention will become apparent from the following description of a preferred embodiment thereof on the basis of the accompanying drawings.

### BRIEF DESCRIPTION OF THE DRAWINGS

FIG. 1 shows part of a rim and a fastening device, and

FIG. 2 shows an enlarged section of the rim with the fastening device and a sensor mounted thereon.

### DESCRIPTION OF A PREFERRED EMBODIMENT

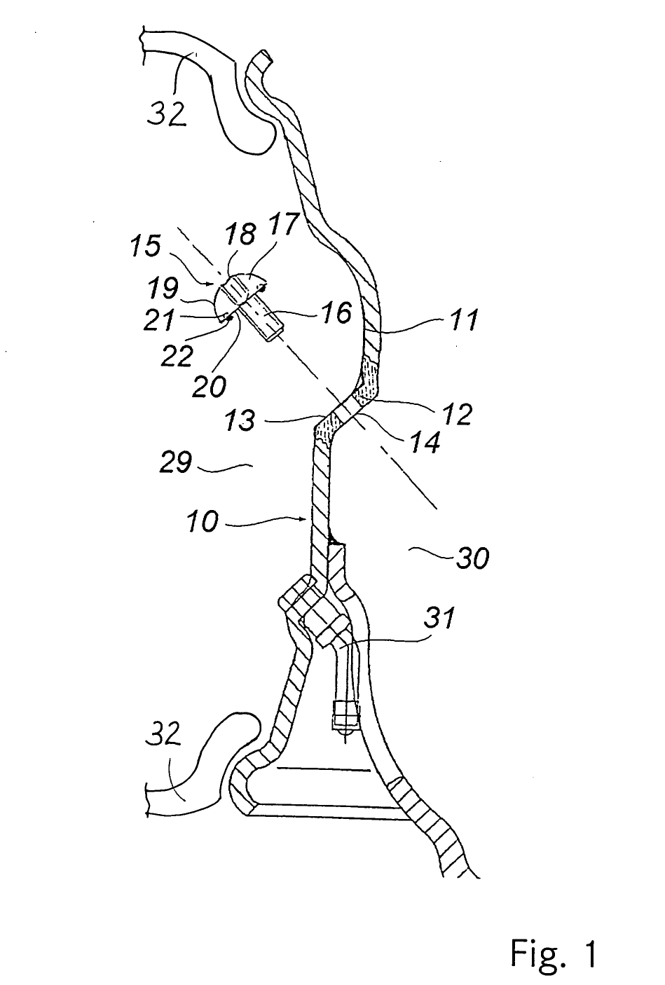

FIG. 1 shows in a sectional view an asymmetrical wheel rim 10 with a well base 11. The rim includes at the transition to the well base 11, an inclined area 12. A tire 32 is mounted on the rim 11 defining an interior space 29. At the side of the interior space 29, the inclined area 12 is provided with a planar surface area 13 with a bore extending therethrough forming a passage 14. The passage 14 interconnects the interior space 29 and the ambient area 30. Further, a fastening device 15 is provided which includes a threaded bolt 16 with a contoured head 17. The threaded bolt 16 form-fittingly insertable into the bore 14. By screwing a nut 24 onto the bolt 16 a form-locking connection is established. The contour head 17 includes a planar base surface 20 with an annular groove 21 in which a seal ring 22 is disposed. The end of the contoured head remote from the threaded bolt 16 has a semi-spherical shape. At this end, the contoured head 19 includes an internally threaded blind end bore 18, which is so arranged that it is axially aligned with the axis of the threaded bolt 16.

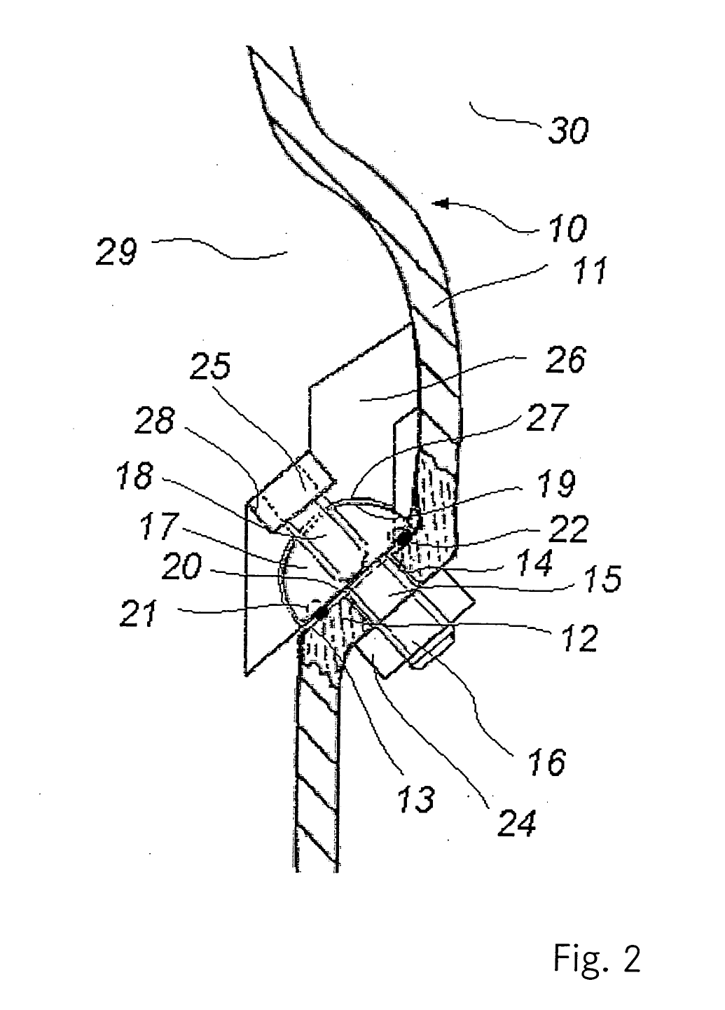

FIG. 2 shows a rim 10 with the attachment device 15 and a sensor 26 mounted thereon. The threaded bolt 16 is inserted into the bore 14 from the interior space 29. A unit 24 is threaded onto the threaded bolt 16 from the ambient area. By tightening the nut 24, the attachment device 15 is connected to the rim under tension in a form-locking manner. However, the nut 24 can again be removed for removal of the attachment device 15.

The arrangement of the seal ring 22 in the annular groove 21 of the contour head 17 of the attachment device 15 provides for the accurate positioning of the seal ring 22, which is important for tight sealing. By tightening the nut 24, the planar surface 20 of the attachment device 15 is pulled toward the planar surface 13 of the rim 10 while causing firm engagement of the seal ring 22 disposed in the groove 21 with the planar surface 13. The interior space 29 of the vehicle wheel is therefore protected from moisture and dirt entering the bore 14 and also from loss of pressurized air from the interior space (29).

The threaded bore 18 in the contour head 17 of the attachment device 15 receives a mounting bolt 18 for mounting the sensor 26 to the attachment device 15. In this way, the sensor 26 is properly positioned on the contour head 17 and attached to the vehicle wheel.

The sensor 26 has a contour contour area 27, which is complementary to that of the contour head 17. In the counter contour area, the sensor 26 is provided with an opening 28 for the reception of a mounting screw 25. The opening 28 may be for example a bore or an elongated groove. The sensor 26 is placed with its counter contour area 27 onto the contour head 17. The opening 28 in the sensor 26 is so arranged that it permits access to the threaded bore 18 in the contour head 17. By means of the mounting screw 25, the sensor 26 is mounted onto the contour head 17 of the attachment device 15. In this way, the sensor cannot only be arranged in different discrete positions, but it may also be rotatable on the contour head 17 about the axis of the mounting screw 25. The shape of the opening 28 in the sensor 26 facilitates the arrangement of the sensor 26 in various positions. If the opening 28 in the sensor 26 is larger than the diameter of the mounting bolt 18, the sensor 26 can be moved laterally with respect to the mounting screw 25. This connection also permits tilting of this sensor 26 about an axis normal to the axis of the bolt 18 before the nut 24 is tightened. The sensor 26 is therefore optimally adaptable to different rims 10 and the conditions provided thereby.

The sensor 26 is so oriented that it is optimally adapted to the shape of the particular rim 10. In this optimum position, it is firmly mounted by tightening the nut 24. Two attachment mechanisms may be utilized. With the first, the sensor is so mounted that the attachment device 15 is firmly connected to the sensor 26 by the mounting screw 25. In this case, the contour 19 of the contour head 17 forms a supportive contact surface area. In another way, the sensor 26 may be so attached that the mounting screw 25 holds the sensor in firm engagement with the rim 10. Where the rim 10 and the sensor 26 are in contact, the rim 10 supports the sensor 26. In this case, the contour head 17 represents only a mounting an for holding the engagement screw 25.

Instead of a semi-spherical head 17 another rotational symmetrical shape may be provided for the contour head 17 such as a truncated cone or a cylinder. Preferably, the sensor 26 is arranged opposite the valve 31 that is, displaced along the rim circumference by 180°. In this way, the imbalance provided by the sensor and the attachment device 15 is at least partially compensated for.

1. A vehicle wheel with a rim (10) for supporting a tire (32) enclosing an interior space and a mounting device (15) for a sensor (26) for detecting at least one measurement value in the interior space (29) of the tire (32), said rim (10) having a bore (14) extending between the interior space (29) and an area (30) ambient to the wheel said mounting device (15) being sealingly mounted in said opening (14).

2. A vehicle wheel according to claim 1, wherein the rim (10) has a central area where the rim (10) has a smaller diameter so as to form an annular deep well (11) with an inclined transition area and the mounting device (15) is arranged in the deep well (11).

3. A vehicle wheel according to claim 1, wherein the mounting device (15) is provided with a contoured head (17).

4. A vehicle wheel according to claim 3, wherein the contoured head (17) of the mounting device (15) includes a threaded bore (18) for mounting the sensor (26).

5. A vehicle wheel according to claim 1, wherein the rim (10) includes a bore (14) into which the mounting device (15) is inserted.

6. A vehicle wheel according to claim 2, wherein the bore (14) is arranged in a planar part of the inclined transition area.(12) at one axial end of the deep well (11).

7. A vehicle wheel according to claim 1, wherein a valve (31) is mounted on said rim (10) and the mounting device (15) is mounted on said rim (10) circumferentially displaced from the valve (31) by 180°.

8. A vehicle wheel according to claim 1, wherein the sensor (26) is mountable onto the mounting device (15) in different positions.

9. A vehicle wheel according to claim 4, wherein the sensor has a contour (27) complementary to the contour (19) of the contoured head (17) of the mounting device (15) so that the sensor is pivotably supported on the contour head (17).

10. A vehicle wheel according to claim 1, wherein the mounting device (15) includes a planar surface area (20) which is provided with a seal (22) which is firmly engaged between the planar surface area (20) and the rim (10).
